(19) United States
(12) Patent Application Publication
(10) Pub. No.: US 2011/0005687 A1
(43) Pub. Date: Jan. 13, 2011

(54) WAVY-EMBANKMENT TYPE CONTAMINATION-FREE ADHESIVE TAPE DISPENSER

(76) Inventor: CHI-TSAI CHANG, Taichung City (TW)

Correspondence Address: LEONG C. LEI, PMB # 1008, 1839 YGNACIO VALLEY ROAD, WALNUT CREEK, CA, 94598, US

(21) Appl. No.: 12/498,380

(22) Filed: Jul. 7, 2009

(51) Int. Cl. B65H 35/07; B32B 37/12

(52) U.S. Cl. 156/523

(57) ABSTRACT

A wavy-embankment type contamination-free adhesive tape dispenser includes a body composed of mated plastic-made halves. The body has a top forming a cutting opening to which a cutter is rotatably mounted. The body halves form central bores each having an inner circumference from which a positioning rim inward extends. The body halves form projecting pegs and hollow cylindrical projections that are fit to each other for coupling, whereby an adhesive tape roll, once received in the dispenser body, is completely enclosed with the positioning rims fit into ring grooves defined in side faces of a central hub of the adhesive tape roll to allow the adhesive tape to be withdrawn through the cutting opening. The outside exposure of the central hub allows a user to access and contact for assisted positioning of the adhesive tape in the operation of withdrawal and cutting of the tape.

### TECHNICAL FIELD OF THE INVENTION

The present invention generally relates to a wavy-embankment type contamination-free adhesive tape dispenser, wherein a plastic made adhesive tape dispenser is composed of two mated and opposite body halves and has a top forming a cutting opening to which a cutter is rotatably mounted for lifting open to carry out cutting or closing for enclosing and the body halves form central bores having inner circumferences from which positioning rims inward extend for fitting to an adhesive tape roll to allow controlled rotation of the adhesive tape roll, whereby with the positioning rims fit into grooves defined in side faces of a central hub of the adhesive tape, inner circumferential surface of the central tube is exposed outside the bores of the body halves to facilitate access, contact, and assisted positioning of the adhesive tape roll in withdrawal and cutting of the adhesive tape so that the cutting can be performed in a stable manner and the whole adhesive tape dispenser features easy replacement and completely enclosed arrangement of the adhesive tape to suit the needs of sanitary and safe application of adhesive tape.

### DESCRIPTION OF THE PRIOR ART

A regular adhesive tape dispenser is constructed as shown in FIG. 5 of the attached drawings, comprising a main body 21 which is formed by integrally connecting thin sheet like side boards 22 that are connected together by a middle-section flat board 23 in such a way to allow bending to form a U-shaped configuration. A surface of the bent middle-section flat board 23 serves as a positioning surface and the flat board 23 has an end forming integrated toothed cutter 24. The opposing side boards 22 form at centers thereof projecting counterpart projection and recess fitting structures that are fit to each other to form a combined axle 25 over which an adhesive tape roll 20 can be fit and supported to form a rotation center. The adhesive tape roll 20, after being unwound and withdrawn, is cut off by the cutter 24. Since the adhesive tape dispenser body 21 has a side-open configuration and the cutting edge of the cutter for cutting off the adhesive tape is exposed, the adhesive tape roll 20 is not in a complete enclosure condition and is thus easily susceptible to external contamination or staining with contaminants and this does not suit the need of safe and sanitary application thereof. This is particularly true for medical purposes for there is more concern about sanitary operation and application of adhesive tapes. Further, the cutting edge of the cutter 24 that functions for cutting is also exposed and it is easy to cause undesired contact, leading to operation safety regarding hurting users and damaging the cutter. For the consideration of sanitary and safe operation in practical uses, and due to the fact that improper constraint of the adhesive tape during the process of force application and cutting of adhesive tape may lead to improper or unsuccessful cutting of the adhesive tape, it often needs to use a finger to hold down the adhesive tape roll 20 to facilitate the cutting operation. Apparently, the existing adhesive tape dispensers require further improvement in view of the above problems.

### SUMMARY OF THE INVENTION

In view of the fact that the existing structures of adhesive tape dispenser are not satisfactory in respect of the needs for safety, practicability, and sanitary operation, the present invention aims to provide a wavy-embankment type contamination-free adhesive tape dispenser, which comprises body members that are fit and mated together to define an interior space in which projecting positioning rims are provided for fitting into an adhesive tape roll to allow the adhesive tape to be withdrawn through a cutting opening that is closable by a cover-like cutter for cutting. With a central hub of the adhesive tape roll being exposed, accessible, and contacted by a user's fingers that hold the dispenser body, the cutting operation of the adhesive tape can be performed in a more stable and convenient manner and further, the cutting edge of the cutter, after the cutting operation, can be properly closed and stored in an enclosed condition. Thus, a complete enclosure of the adhesive tape is realized and an effect that ensures safe and sanitary application of the adhesive tape is provided, by which the drawbacks of the conventional adhesive tape dispensers that do not provide satisfactory safe, practicable, and sanitary application of adhesive tape are eliminated.

The primary objective of the present invention is to provide an adhesive tape dispenser that has a structure arranged in a beautified configuration and allows easy assembling and application of adhesive tape. With a central hub of the adhesive tape roll exposed outside the dispenser body, assisted positioning for the rotation and withdrawal of the adhesive tape is realized. Thus, the application of the adhesive tape meets the needs of complete and sanitary enclosure. The cutting operation of the adhesive tape can be done with ready application of force. The cutting edge of the cutter can be stored in such a way to make the outside appearance of the dispenser beautiful and satisfying the needs of easy assembling and sanitary operation.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an adhesive tape dispenser in accordance with the present invention.

FIG. 2 is a perspective view of the adhesive tape dispenser of the present invention in an assembled form.

FIG. 3 is another perspective view of the adhesive tape dispenser of the present taken from a different side.

FIG. 4 is a cross-sectional view illustrating withdrawal and hand assisted positioning of adhesive tape from the adhesive tape dispenser of the present invention.

FIG. 5 is a perspective view of a conventional handheld adhesive tape dispenser.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

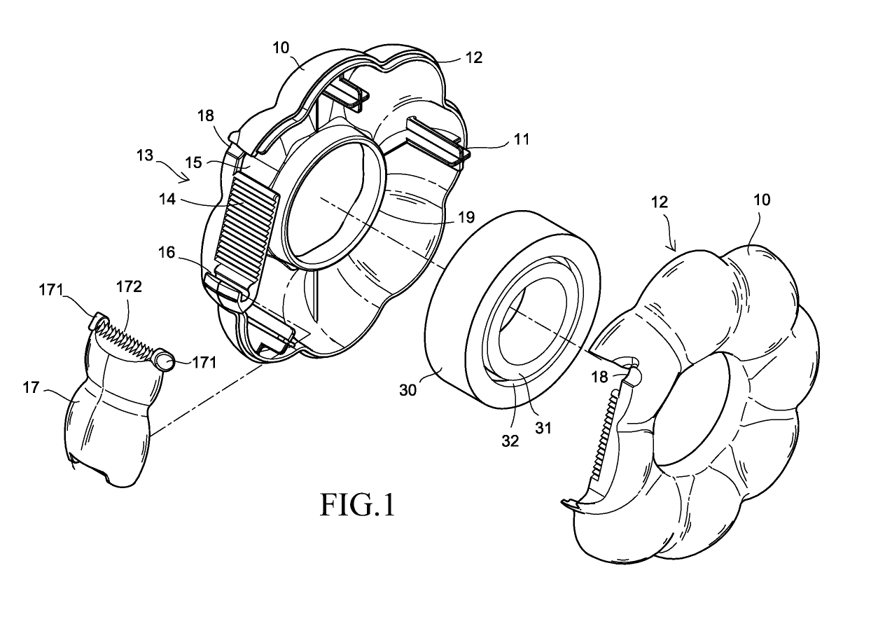

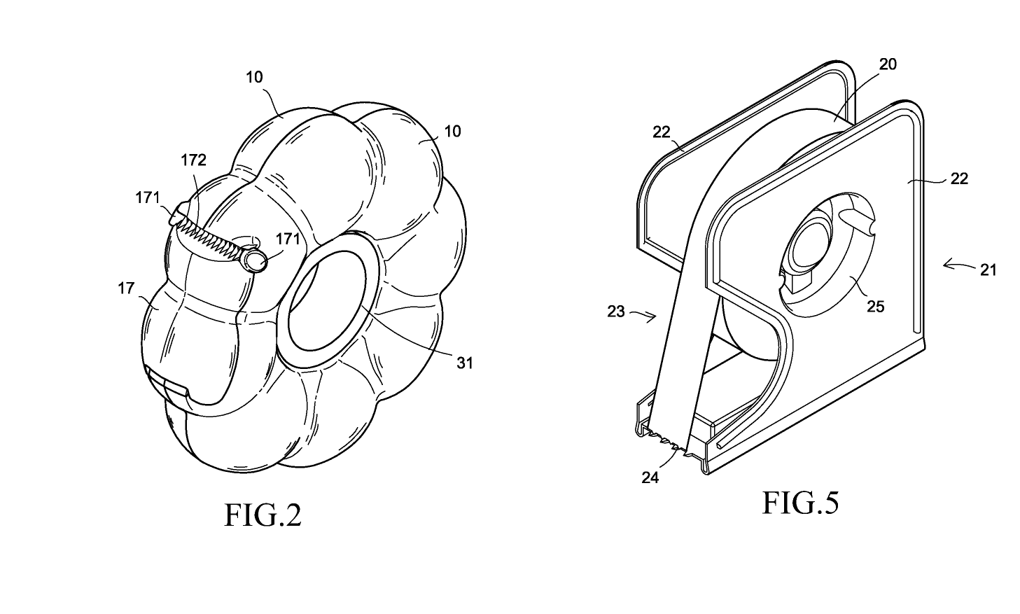

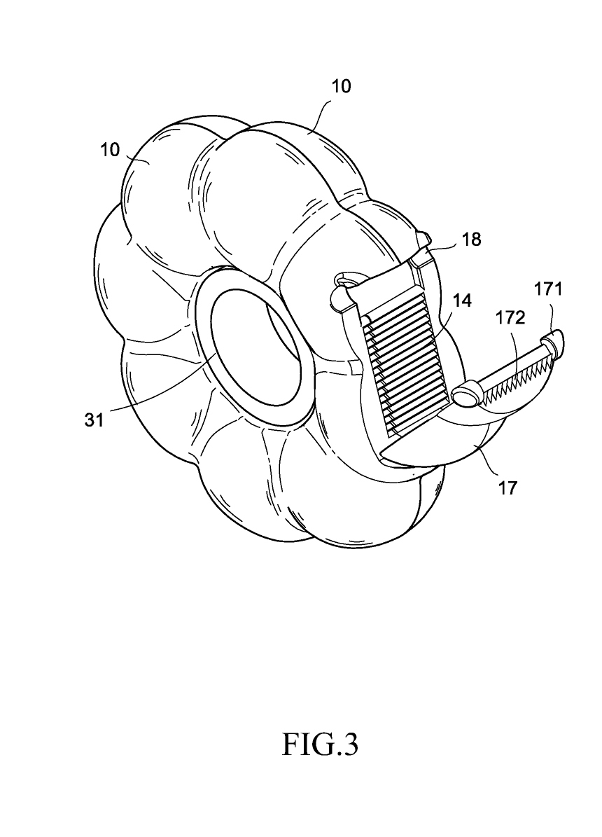

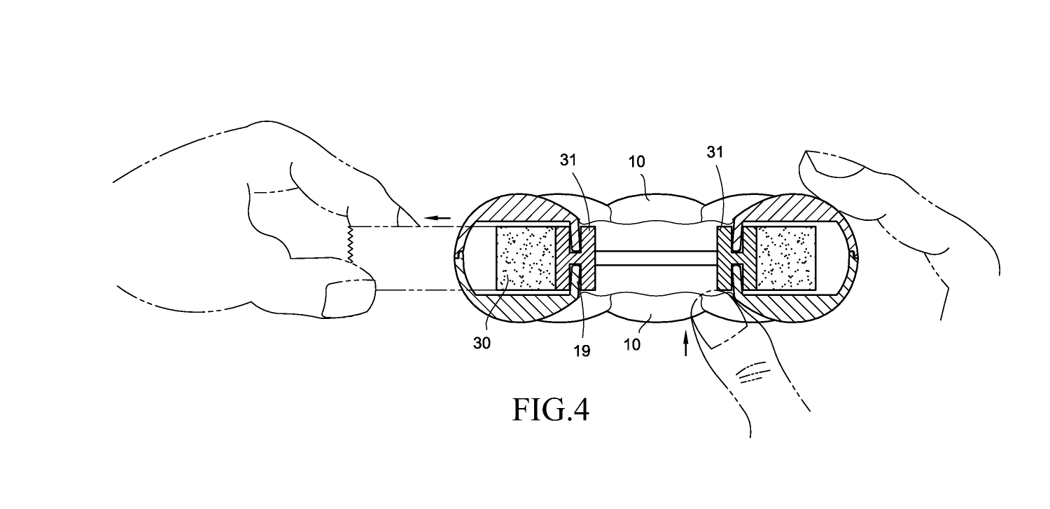

The present invention provides a wavy-embankment type contamination-free adhesive tape dispenser, which is structured to facilitate the deposition of a roll of adhesive tape into the adhesive tape dispenser and also offer a practical effect of well control of cutting and dispensing of the adhesive tape. FIGS. 1-4 of the attached drawings show the structure of the wavy-embankment type contamination-free adhesive tape in accordance with the present invention, wherein the adhesive tape dispenser is formed by mating two symmetrically-shaped body halves 10, of which one body half 10 forms internally a plurality of protuding positioning pegs 11 that is insertable into and engageable with insertion slots (not shown) defined corresponding cylindrical projections formed on the other body half to couple together. The body halves 10 have mating circumferences respectively forming raised and recessed flanges 12 that are engageable with each other for beautifying the mated joint of the coupled body halves 10. The combined body of the two halves 10 has a top forming a cutting opening 13 that is slightly recessed with respect to an outer surface of the body. To provide a desired structural stiffness and to accommodate an extended segment of adhesive tape, an extension board 14 is provided under the cutting opening 13 and has a roughened surface. A free end of the board borders a tape withdrawal slot 15 with respect to the cutting opening 13. The extension board 14 has an opposite, fixed end connected to the body of the combined halves 10 and a pivotal joint slot 16 is formed in the fixed end of the extension board 14 in a recessed manner for rotatably coupling with a cutter 17 that has a configuration matching an outside surface of the body 10, whereby an end of the cutter 17 is directly and rotatably received in the pivotal joint slot 16 with a pivot formed thereon, realizing a rotatable opening/closing structure. On opposite sides of the tape withdrawal slot 15, the body 10 forms two fastening sections 18 that engage and secures fastening pegs 171 provided on opposite sides of the free end of the cutter 17, so as to securely retain a cutting edge 172 that is slightly recessed in the free end of the cutter inside the wall of the body of the halves 10 without any exposure to cause undesired contact and hurt of a user and demonstrating satisfactory real safety of use. Each body half 10 has a central portion forming a bore having a circumference from which a positioning rim 19 in the form of a closed circumferential wall extends inward, whereby in mounting an adhesive tape roll 30, the positioning rim 19 is inserted into a ring groove 32 defined in a side face of a central hub 31 of the adhesive tape roll 30 to serve as a rotation support for the adhesive tape roll 30. An inner circumferential surface of the central hub 31 of the adhesive tape roll 30 is thus partially exposed outside the central bores of the combined body halves 10. When the adhesive tape is being withdrawn outside for use, the central hub 31 is rotated and the rotation can be readily inspected outside and the user's hand is allowed to touch the central hub 31 for positioning assistance in carrying out cutting of the adhesive tape, whereby the application and cutting of the adhesive tape is made more stable and the cut is neat. The adhesive tape dispenser is structured in such a way to allow controlled rotational positioning when the adhesive tape roll 30 is rotated for withdrawal of the adhesive tape, so that the operation of the adhesive tape can better suit the needs of safety and practicability and a novel and practical structure is made with respect to the existing adhesive tape dispensers.

The structure of the body halves 10 of the adhesive tape dispenser in accordance with the present invention feature the rotary assembling of the adhesive tape roll 30 is realized by directly fitting the positioning rims projecting inward from the body halves 10 into the side faces of the central hub 31 of the adhesive tape roll 30 to have the central hub 31 partly exposed outside the body halves 10. This may be combined with a desired change of color the material thereof to make the assembled adhesive tape dispenser more flexible in respect of vivid coloring, which enhances the flexibility of visual aesthetics. When the central hub 31 is rotated with the withdrawal of the adhesive tape, unique and ready visual inspection is provided and positioning assistance for effective control of the withdrawal speed and extension length of the adhesive tape is realized, leading to stable and firm application and cutting of the adhesive tape. The cutter 17 can be securely retained and positioned on the outside appearance of the body halves 10 and this makes the outside appearance of the adhesive tape dispenser beautiful and configurable as circle or rectangle or other shapes as desired, for the concealed storage of the cover-like cutter allows it to maintain the outside appearance of the article and to ensure that the adhesive tape is secured for being enclosed and the needs of safety for application, cutting, and carrying are met, so that the adhesive tape is made contamination free and safe in respect of storage and safety of the cutter and also offering a practical and sanitary effect in respect of positioning for cutting. In view of the practical design in respect of simplified structure and easy and practical assembling, these features are not found in any of the existing adhesive tape dispenser. The structure of the present invention is simple, practical, safe, and offering practical effect of suiting the needs of sanitary and is a novel design for the structure of adhesive tape dispenser.

To summarize, the wavy-embankment type contamination-free adhesive tape dispenser of the present invention provides a rotary design by simply fitting positioning rims projecting from central bores into a central hub of an adhesive tape roll and this not only offers enclosures sanitary and safe, integral and beautiful storage of the cutter, but also provides assistance for positioning of the adhesive tape withdrawn from the dispenser for the extension of a desired length and the cutting thereof, whereby the needs of practicability and safety of the application of the adhesive tape is realized. Through change of color of the central hub of the adhesive tape roll and the dispenser body, the outside appearance of the adhesive tape dispenser is made more beautiful. The whole structure not only offers the effect of use in respect of structural safety and sanitary, but also meets the need of novelty of design and assembling, completely suiting the need of modern people.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wavy-embankment type contamination-free adhesive tape dispenser, comprising a combined body having a top forming a recessed cutting opening, a cutter being arranged outside cutting opening, an adhesive tape body being received inside the body, characterized in that the body is formed by combining and mating, in a fitting manner, two symmetric body halves and forms in the top thereof the recessed cutting opening outside which the cutter is set in a rotatable manner to cover and complete an outside appearance of the dispenser, each body half forming a central bore having an inner circumference from which a positioning rim inward projects for fitting into a ring groove defined in a side face of a central hub of the adhesive tape body, whereby when an end of adhesive tape of the adhesive tape body is withdrawn outside and the adhesive tape body rotates for dispensing the adhesive tape, the central hub is accessible and engageable by a user's hand for controlled positioning and realization of operation assistance for controlling extension length of the adhesive tape and stable cutting of the adhesive tape, so as to provide integral enclosure and cutting safety of the adhesive tape.

2. The wavy-embankment type contamination-free adhesive tape dispenser according to claim 1, wherein the cutting opening of the dispenser body comprises a recessed extension board having a connected end in which a pivotal joint slot is defined for rotary coupling of the cutter.

3. The wavy-embankment type contamination-free adhesive tape dispenser according to claim 1, wherein inside surfaces of the body halves are respectively provided with projecting pegs and tubular cylindrical projections for fitting and mating each other.

4. The wavy-embankment type contamination-free adhesive tape dispenser according to claim 1, wherein the central tube of the adhesive tape body and the dispenser body is changeable in respect of color thereof.

5. The wavy-embankment type contamination-free adhesive tape dispenser according to claim 2, wherein the extension board has a roughened surface.

6. The wavy-embankment type contamination-free adhesive tape dispenser according to claim 1, wherein the cutting opening is provided with engaging sections respectively above a tape withdrawal slot for engaging fastening pegs formed on an end of the cutter to realize fastening and positioning in closing the cutter.

7. The wavy-embankment type contamination-free adhesive tape dispenser according to claim 1, wherein dispenser body is made in the form of a circle, a rectangle, or other shapes.
